(19) United States
(12) Patent Application Publication
(10) Pub. No.: US 2005/0185209 A1
(43) Pub. Date: Aug. 25, 2005

(54) System, apparatus, and method for printing and erasing screen-based images

(76) Inventors: Yosef Kamir, Netanya (IL); Uri Adler, Holon (IL); Serge Steinblatt, Ra'anana (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/784,214

(22) Filed: Feb. 24, 2004

(51) Int. Cl. G06F 15/00

(52) U.S. Cl. 358/1.14

(57) ABSTRACT

A printing apparatus and display system including a detachable printing apparatus that enables printing and/or erasing of display information directly to and/or from display systems. The printing apparatus may print and delete color images to/from a substrate using a printing mechanism and a plurality of color toners, using a detachable mobile printing apparatus. The printing apparatus may enable recycling of erased toner from previously erased images.

### FIELD OF THE INVENTION

The present invention relates to printed display boards in general, and more particularly to a system, apparatus and method for enabling printing on display boards and erasing there from.

### BACKGROUND OF THE INVENTION

One common form of displaying media uses poster displays located at strategic locations for maximum exposure. Various methods and systems are used to print content on such poster displays. Further, methods and systems are known for enabling remote printing or writing on such poster displays, as described in US application, publication no. 20020109663 A1, and PCT application WO 02/065433 A2, both by a common inventor, which are incorporated by reference in their entirety.

Printing apparatuses that may be integrated with printable display systems may be exposed to outdoor elements and/or vandalism that may damage various elements of the apparatus, and in particular, the printing apparatus. It would be highly advantageous to have an improved system and/or method to enable usage of a detachable printing apparatus for printing (writing) and deleting of content directly to/from display boards.

### SUMMARY OF THE INVENTION

The present invention provides a printing apparatus and display system that enables printing and erasing of content directly to/from display apparatuses, such as billboards, notice boards, advertisement boards and any other display surfaces used for presenting, promoting, advertising and/or publicizing information. The present display system may enable a detachable printing apparatus to write (hereinafter referred to as “print”) a color image on at least one substrate of a multitude of display systems, using a printing mechanism and one or more color toners, and erasing the image from the substrate. In this way one printing and/or erasing apparatus may be used to write and/or erase content to and/or from multiple display systems.

Moreover, in accordance with an embodiment of the present invention, the printing apparatus and display system may identify each other or one another, and upon verification of their identities, may continue execution of printing and/or deleting commands.

Furthermore, in accordance with an embodiment of the present invention, the printing apparatus and/or display system may communicate with a printer server, to send/receive commands and/or data.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic illustration of an embodiment of a printable display system, as is known in the art;

FIG. 2A is a schematic illustration of a display system, according to an embodiment of the present invention;

FIG. 2B is a schematic illustration of a printing apparatus, according to an embodiment of the present invention;

FIG. 3 is a schematic illustration of a display system, according to an embodiment of the present invention, with a detachable printing apparatus attached;

FIG. 4 is an illustration of a narrow display system, according to an embodiment of the present invention;

FIG. 5 is an illustration of a narrow display system, according to an embodiment of the present invention, with a mobile printing apparatus attached;

FIG. 6 is an illustration of a narrow display system, according to an embodiment of the present invention, where a substrate is stretched over the deleting and printing units of a printing apparatus; and

FIG. 7 is an illustration of a method of implementing an embodiment of the present invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

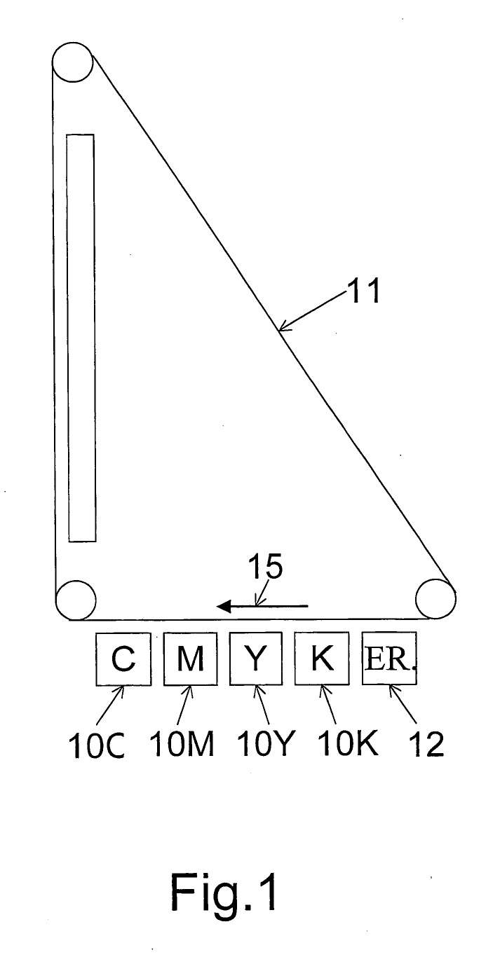

The printing apparatus and display systems according to the present invention may be similar in construction and operation to parts of the system described in embodiments of US application, publication no. 2002/0109663 A1 and/or PCT application WO 02/065433 A2, both by a common inventor, which are incorporated by reference in their entirety. Other embodiments of the present invention may use different construction and different methods. As can be seen in FIG. 1, the erasing of an image from an imaging belt 11 may occur at erasing unit 12 while the imaging belt 11 is moving, for example, clockwise, as indicated by arrow 15. Imaging and printing of a new color image may occur after the erasing of a prior image at erasing unit 12, for example, at the cyan (C), magenta (M), yellow (Y), and/or black (K) units, respectively 10C, 10M, 10Y and 10K. Other suitable colors and color systems may be used.

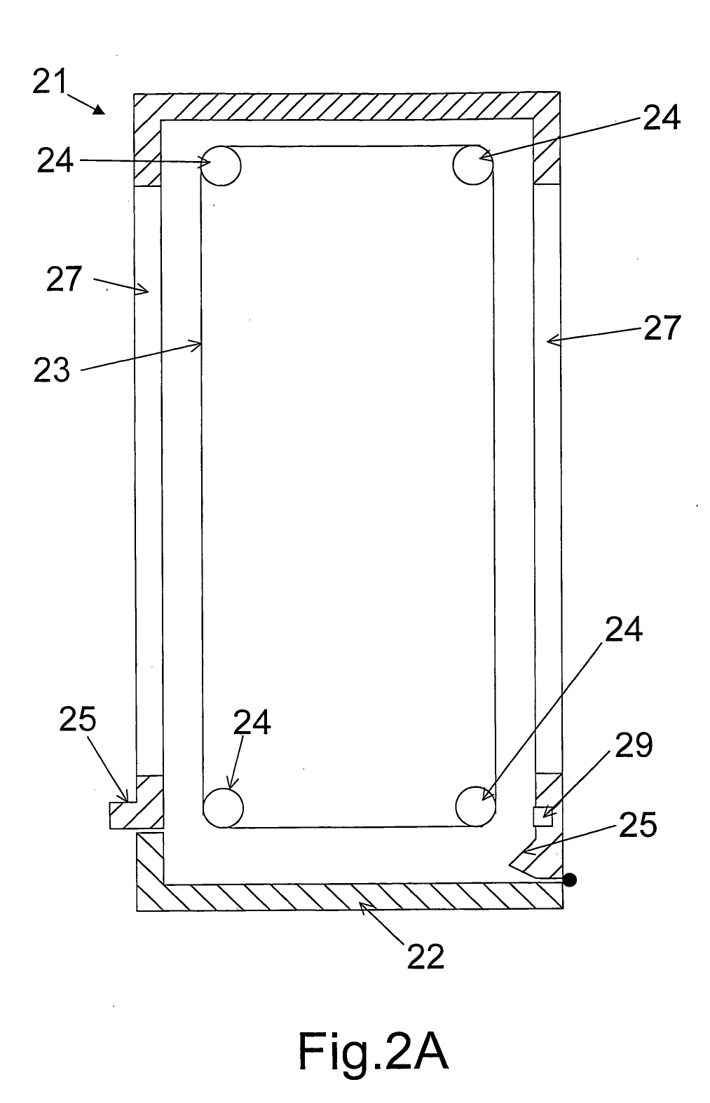

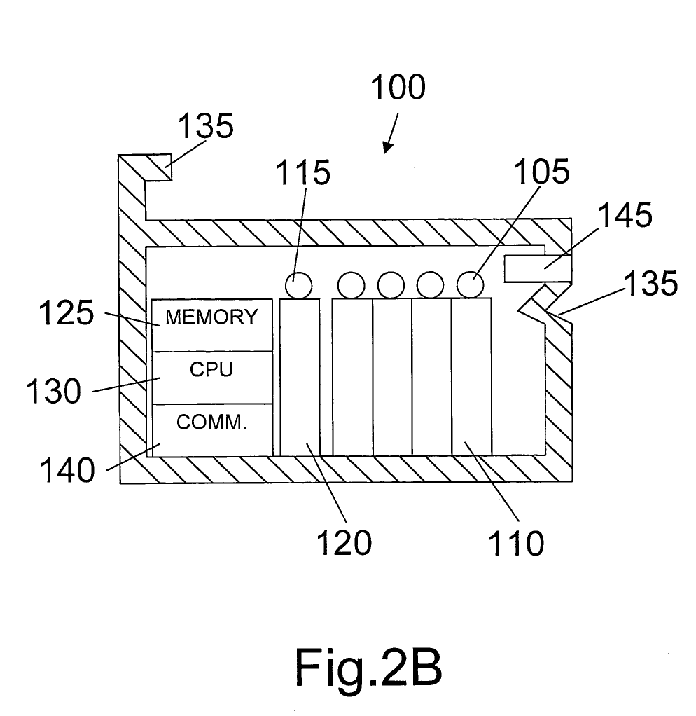

Reference is now made to FIG. 2A which is a schematic block diagram illustration of a display system 21, according to some embodiments of the present invention. Display system 21 may have at least one viewing window 27 for viewing of, for example, an internal substrate. Display system 21 may have a casing cover 22 that may be openable to enable a printing apparatus (described herein) to connect to display system 21, and/or for entering a substrate and printing/deleting mechanisms etc., as are described in detail below. Display system 21 may have a printing substrate 23 for displaying printed images. Display system 21 may have guiding rollers 24 for enabling substrate 23 to be rolled over a suitable printer mechanism (described herein), for configuration, removal, deletion and printing etc. Display system 21 may include at least one attachment or registration mechanism 25 corresponding to a corresponding attachment or registration mechanism of an attachable printing apparatus, to enable such a printing apparatus to be securely and accurately attached to display system 21. The attachment or registration mechanisms of the screen based display and printing apparatus may be capable of being mated and may hold the systems together. Various ways of achieving registration may be implemented, for example, using precision mechanical pins and holes, precision pins and slots, and/or other suitable mechanical solutions.

Display system 21 may have an identifier 29, which may include identity data or other suitable identifiable means for enabling identification of a display system to a printer apparatus and/or printer server. Identity verification may be used, for example, to enable a printing apparatus to determine which images are to be printed and/or deleted from one or more display systems 21, or to execute other suitable operations. In one embodiment identifier 29 may be stored in, for example, a memory unit, and operated by a logic circuit or controller within display system 21. The logic circuit may be a generic or dedicated controller, for managing printing operations of display system 21. Identifier 29 may be stored in display system 21 in any format, for example, in a bar code form, magnetic strip form, as a mechanical key, or in other suitable forms, such that upon scanning or otherwise determining the identity data of display system 21, display system 21 may be identified to an attachable printing apparatus and/or printing server.

Display system 21 may have an identifying mechanism (not illustrated in figure), such as a data scanner mechanism (e.g., a barcode scanner), magnetic strip reader, mechanical key reader, or other suitable mechanism, for determining identity data of an attachable printing apparatus, following a registration (e.g., connection or attachment) procedure of a printing apparatus. The identifying mechanism may send the identification data to a logic circuit for verification. In the case where a display system is positively identified (e.g., matched) with a printer apparatus, such a printer apparatus may implement the relevant printing/delete or other commands for display system 21.

Display system 21 may have a communication mechanism (not illustrated in figure) for sending and/or receiving data to/from an attachable printing apparatus, via wire-based, for example, an electronic circuit and connection pins, antenna, wireless communication chip etc. The communication mechanism may enable display system 21 to communicate with an attachable printing apparatus and/or a data server etc.

Reference is now made to FIG. 2B which is a schematic block diagram illustration of a detachable printing/erasing apparatus 100, according to some embodiments of the present invention. The detachable printing apparatus 100 may be attached to one or more display systems 21, and may thereby print on and/or erase from a plurality of display systems. The detachment of the printing apparatus 100 from display system 21 may enable, for example, preservation and protection of the printing apparatus 100, and may enable multiple printouts and erasures of images using for example xerographic, ionographic, magnetographic or other suitable printing methods.

Detachable printing apparatus 100 may include at least one printing unit 105, for printing images on the substrate. Each printing unit, e.g., unit 105, may include, for example imaging heads for pre-printing using light. Printing units may have, for example, printing heads, inkjet heads, or other suitable printing heads. Printing unit 105 may include, for example, toner or inkjet cartridges 110. Printing apparatus 100 may include an erasure unit 115, for erasing images from the substrate. Erasure unit 115 may be associated with a toner or inkjet receptacle 120, for collecting the deleted toner or ink from deleted images.

Printing apparatus 100 may include at least one memory device 125. Memory device 125 may store relevant system data, network data and image data, etc. Image data may include previous, current, and future images for display system 21. Memory device 125 may also store relevant display system data, such as identity data, such that all display systems 21 that are configured to be served by a printer apparatus 100 may be identified and interacted with by printing apparatus 100. Memory device 125 may also store relevant printing and erasing data, for enabling printing and erasing operations by printing apparatus 100 and/or display system 21. Memory device 125 may be an internal memory device and/or an external memory device.

Printing apparatus 100 may include at least one controller, logic circuit, or CPU 130, which may be a generic or dedicated processor, for managing printing, deleting, and other suitable operations of printing apparatus 100 and/or display system 21. For example, controller 130 may enable printing apparatus 100 to verify which images are to be printed and/or deleted to/from display system 21, and implement the relevant printing/deleting commands and other suitable operations for each particular display system 21.

Printing apparatus 100 may include at least one registration or attachment mechanism 135 that may be a mechanical component, or a set of mechanical components, to connect with at least one matching or associated registration mechanism in display system 21, e.g. mechanism 25. These matching registration components may function to connect, secure, and/or lock printing apparatus 100 into display system 21, for example, to execute printing, deleting and/or other suitable operations.

Printing apparatus 100 may include a communications unit 140, which may include hardware and/or software components, to send/receive data to/from an external data server, printer server etc. (not illustrated in figure), and/or to send/receive data to/from display system 21. Data may be transmitted via wire-based means (e.g., electronic circuit, connection pins etc.) and/or wireless means (e.g., a wireless communication chip that may enable printing apparatus 100 to communicate with a display system 21 or external printer server etc. even when not physically connected to a display system or data server etc.).

Printing apparatus 100 may include an identifying mechanism 145 to enable printing apparatus 100 and/or a printer server etc. to identify display system 21. The identifying mechanism may include, for example, a data scanner mechanism (e.g., a barcode scanner), magnetic strip reader, mechanical key reader, computer code etc., to enable printing apparatus 100 to determine identity data of display system 21. For example, before, during, or after a registration (e.g., connection or attachment) procedure of printing apparatus 100 and display system 21, identifying mechanism 145 may read identifier 29, and send the read identification data to controller 130 for verification. In the case, for example, where a particular display system 21 is positively identified (matched) with a printer apparatus 100, printer apparatus 100 may implement the relevant printing, deleting, or other suitable commands for display system 21. Of course, other suitable structures, components, and dimensions may be used.

Printing apparatus 100 may include an identifier (not shown in figure), for example, a number, code, password, barcode, or any other identifiable means, for enabling identification of a particular printing apparatus 100 to display system 21.

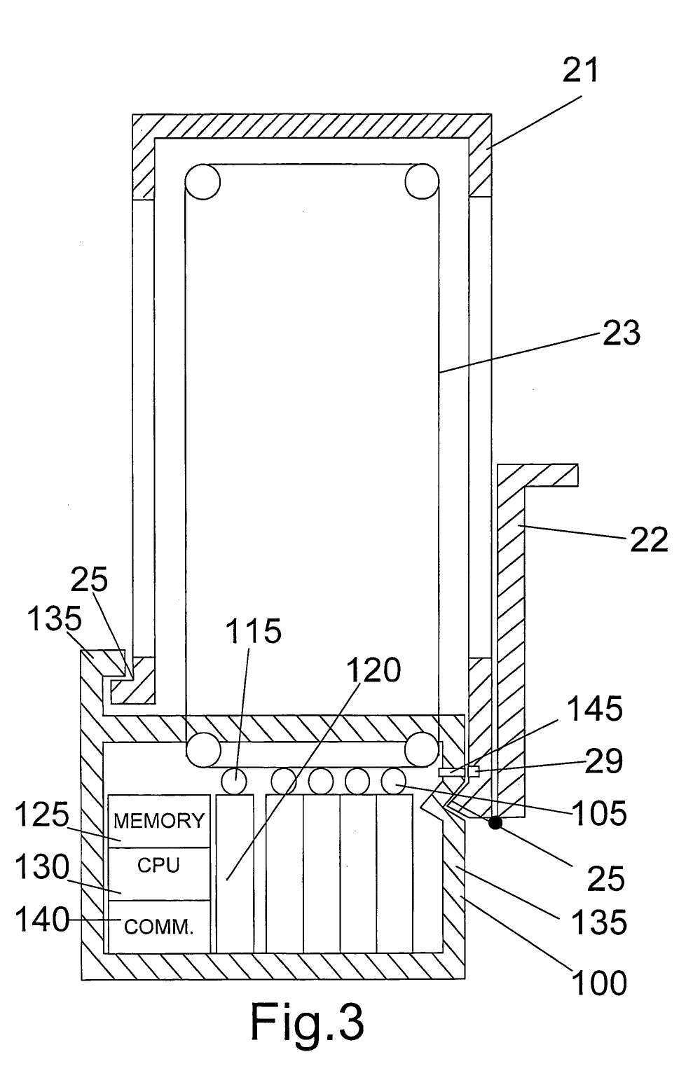

FIG. 3 illustrates a printer apparatus 100 connected to a display system 21, according to some embodiments of the present invention. Display system 21 may include an openable display casing 22, which may be opened to allow the printer apparatus 100 to be attached to display system 21. Registration mechanism(s) 25 may connect to or be otherwise associated with registration or attachment mechanism(s) 135, to hold printer apparatus 100 in place, for example to enable substrate 23 to be aligned with printing unit 105, imaging unit, and deleting unit 115 etc. of printing apparatus 100. Identification mechanism 145 may be associated with identifier 29, to enable identification of display system 21.

According to some embodiments of the present invention, printing apparatus 100 may have an apparatus for recycling or otherwise collecting the deleted toner or ink from toner or ink receptacle 120, for example for re-use in further printing. A method and apparatus to recycle or collect toner deleted from a display is described in embodiments of U.S. patent application Ser. No. 10/745,596, titled “APPARATUS AND METHOD FOR RECYCLING TONER IN A PRINTED IMAGE DISPLAY SYSTEM”, which is incorporated by reference in its entirety.

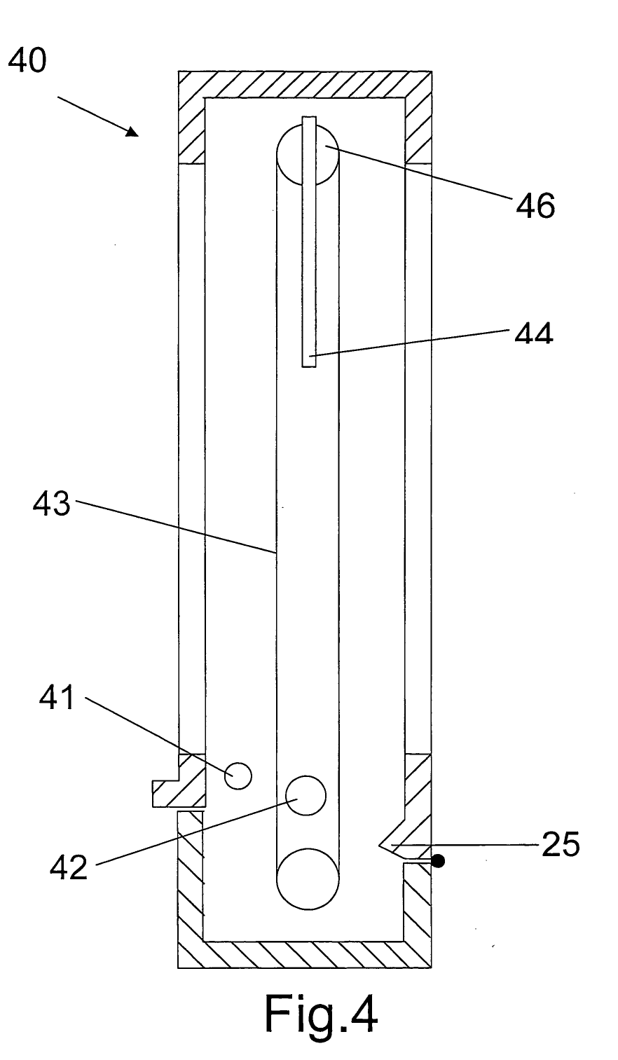

According to some embodiments of the present invention, printing apparatus 100 may be too wide to fit into a narrower display system 40 structure, as can be seen with reference to FIG. 4. Display system 40 may include, for example, one or more auxiliary guiding rollers 41, 42 positioned such that auxiliary guiding rollers 41, 42 may engage one or more sliding mechanisms following a registration procedure of a printing apparatus 100. One or more auxiliary slides, e.g., slide 44, may additionally or alternatively be added to narrow display system 40. Auxiliary slide 44 may be provided within narrow display system 40, to enable at least one upper roller 46 to change position by sliding along auxiliary slide 44. According to some embodiments of the present invention, an additional auxiliary slide may be integrated into display system 40. Such an integration may require the auxiliary slide to be positioned such that following attachment or registration of printing apparatus 100 to display system 40, the additional auxiliary slide may be engaged and moved into an appropriate operating position. Display system 40 may include at least one registration mechanism 25, corresponding to a corresponding registration mechanism of an attachable printing apparatus, to enable such a printing apparatus to be securely and accurately attached to display system 40.

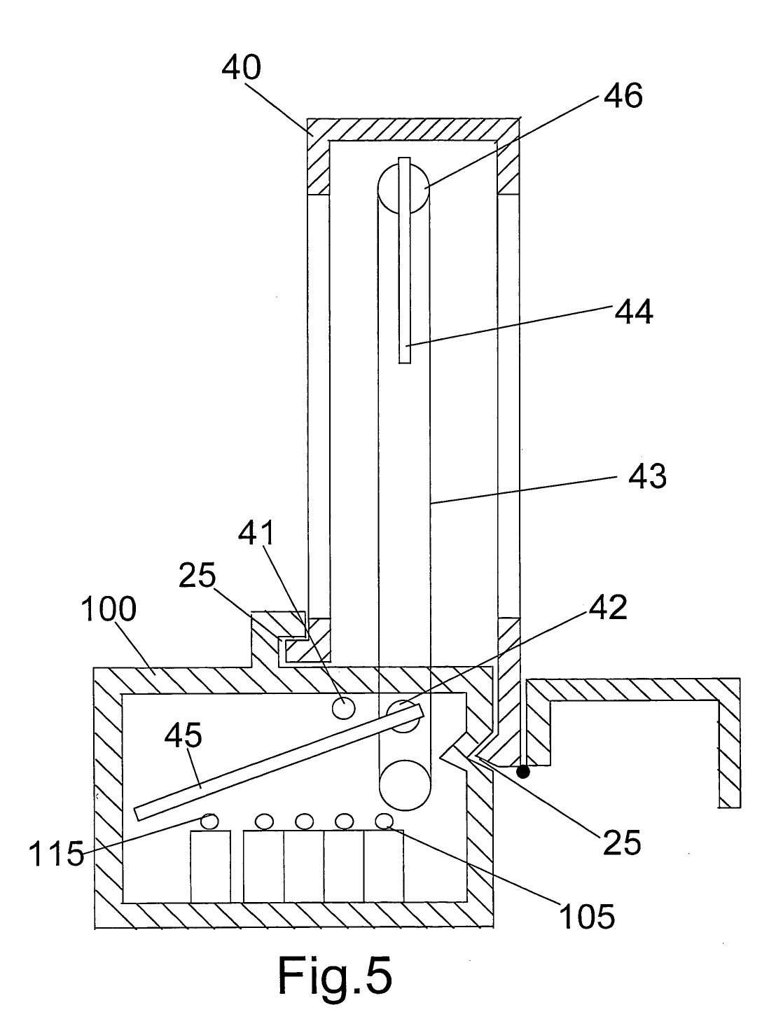

Reference is now made to FIG. 5, which illustrates a printing unit attached to a to narrow display system 40, according to some embodiments of the present invention. In some embodiments, at least one additional (auxiliary) slide 45 may be provided within printing apparatus 100 and/or display system 40, such that following a mechanical registration procedure by means of which printing apparatus 100 connects with or locks into display system 40, a relevant auxiliary slide 45 may be placed in an appropriate position to engage auxiliary roller 42, thereby enabling at least one auxiliary roller to slide along slide 45 into operating position.

Since display system 40 may have a depth that is too narrow to accommodate a printer apparatus 100, printer apparatus 100 may be attached to display system 40 such that at least one registration mechanism 25 is engaged to a corresponding registration mechanism of an attachable printing apparatus 100, to enable such a printing apparatus to be securely and accurately attached to display system 40. Following registration (connection) of printing apparatus 100 to display system 40, auxiliary roller 42 may engage auxiliary slide 45. This engagement may enable bending and/or maneuvering of substrate 43 into an alternative position that is accessible to the printing units 105 and deleting unit 115 within printing apparatus 100, to enable deleting and printing of images by printing apparatus 100. Attaching of the printer apparatus 100 may trigger auxiliary roller 42 to move along slide 45, until roller 42 is placed, for example, adjacent to deletion unit 115 of printing apparatus 100, or in an otherwise suitable position to enable appropriate positioning of substrate 43. Attaching of printing apparatus 100 to display system 40 may trigger upper guide roller 46 to move along slide 44, to compensate for the movement of auxiliary roller 42 as described above.

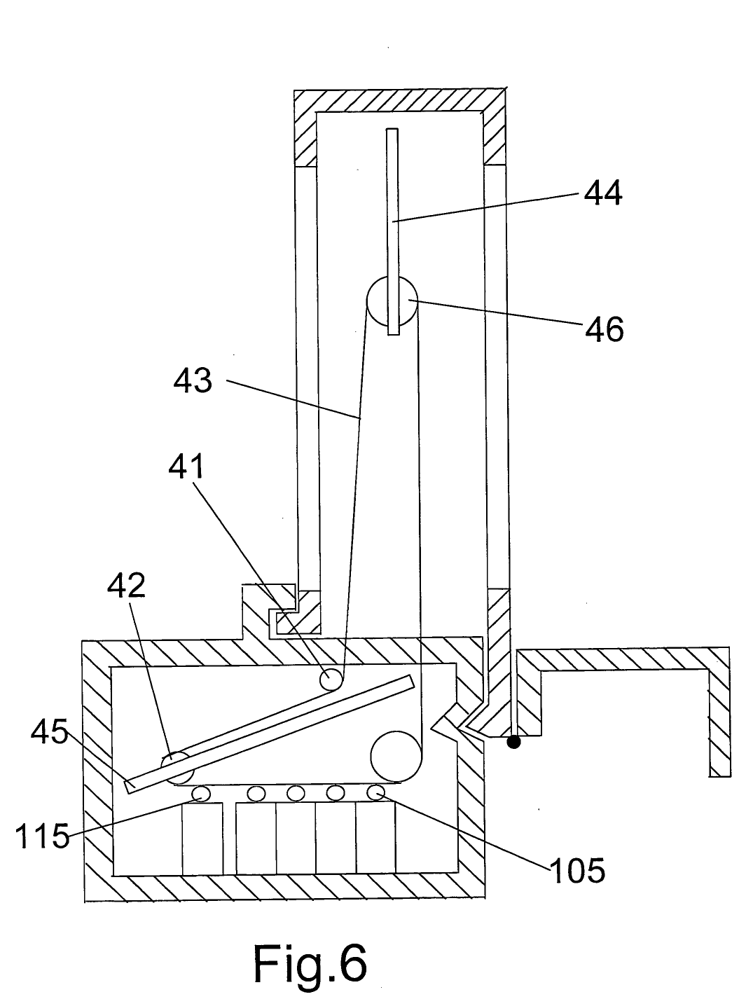

As can be seen with reference to FIG. 6, both auxiliary guide roller 42 and guide roller 46 may move along auxiliary slides 44, 45 respectively until auxiliary roller 42 is located, for example, adjacent to deletion unit 115, or in an otherwise suitable position to enable appropriate positioning of substrate 43. The new positioning of auxiliary roller 42 may, for example, stretch substrate 43 from auxiliary guide roller 41 to auxiliary roller 42, such that substrate 43 is placed in line with deletion unit 115 and printing units 105, thereby being in a position ready for deletion and/or printing. Such a mechanism may be used for any size display system that is narrower than the width of a printing apparatus 100.

According to an embodiment of the present invention, a printing apparatus 100 may provide monochrome or colored printing, for example, using a four-color printing mechanism on a display system 21 or 40, in the case of a narrow display system), which may have at least one substrate, to enable multiple printing of color images. Other suitable color systems may be used. Display system 21 may include a display surfaces that may have images printed on them, such as billboards, advertisement panels and/or alternative display panels. Display system 21 may be connected to a communication network, such that instructions can be transferred between a data server, web server, print server etc. and display system 21, for example, to print a new image, erase a current image, display the new image, and communicate display status etc. Alternatively, or additionally, these instructions may be given to and/or received from detachable printing apparatus 100.

Printing apparatus 100 may enable printing and deletion of images for multiple display systems 21, 40, and may contain or have access to printing/deleting data for a plurality of display systems 21, 40. Images on display systems 21, 40 may be printed using xerographic, ionographic, magnetographic or any suitable printing method, on at least one single substrate. Printed images may not be fused on the substrate on which they are printed, thereby enabling deletion of the printed images and their replacement by new images. The detachable printing apparatus 100 may be connected to display system 21 using at least one connector or registration mechanism 25. Upon connection, or registration, of printing apparatus 100 to display system 21, 40, printing apparatus 100 may identify display system 21, 40 and implement the relevant printing/deletion instructions. According to other embodiments of the present invention, printing apparatus 100 and display system 21, 40 may identify each other before executing the printing/deleting commands. According to other embodiments of the present invention, display system 21, 40 may identify printing apparatus 100 before executing the printing/deleting commands.

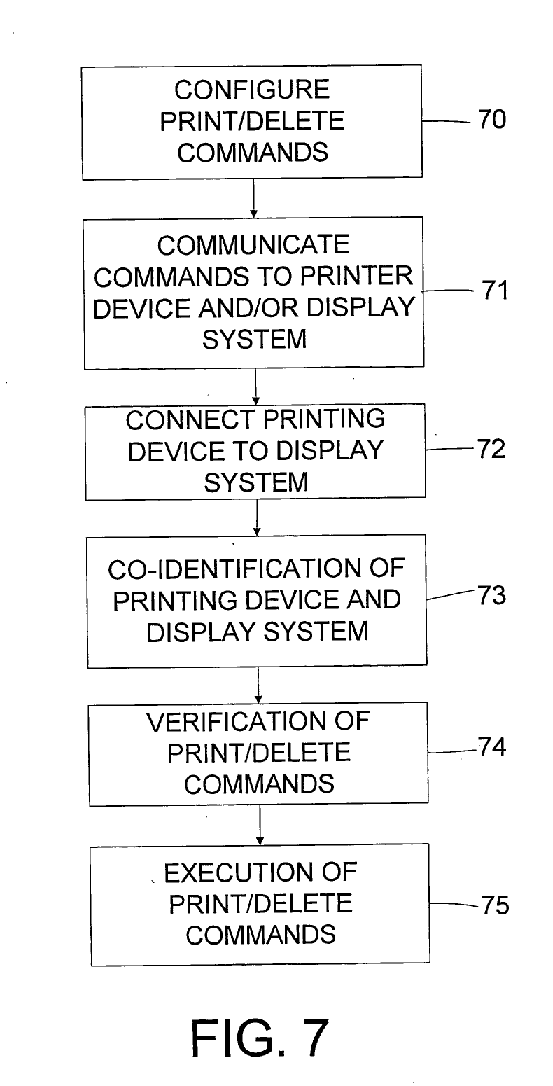

Reference is now made to FIG. 7, which illustrates a method to enable printing and/or deletion of content directly to/from a display system 21, 40 using a detachable printing apparatus 100. At block 70 image deletion and/or printing commands may be configured, either within printing apparatus 100, display system 21, 40, or at a data and/or print server etc. At block 71 these commands may be communicated to either a printing apparatus 100 and/or a display system 21 using a data or printer server etc., display system 21, 40, or printing apparatus 100. At block 72 a detachable printing apparatus 100 may be attached to display system 21, 40 such that one or more connection mechanisms and/or registration mechanisms may connect printing apparatus 100 to display unit 21, 40. At block 73 printing apparatus 100 may identify display unit 21, 40 and/or display unit may identify printing apparatus 100. This identification and/or co-identification may include, for example, identification of printing apparatus 100 and/or display system 21, 40 by an identifying mechanism in printer apparatus 100 and/or in display system 21, 40. For example, a data scanner mechanism (for example a barcode scanner), magnetic strip reader, mechanical key reader, software code etc., may be used following a registration (connection) procedure. The identifying mechanism may send the identification data to a logic circuit for verification, located at any suitable location. At block 74 the print and/or delete commands may be verified for display system 21, 40. At block 75 printing and/or delete commands may be executed by printing apparatus 100.

In the case where commands are communicated from a printing apparatus 100 to display system 21, these commands may be communicated via for example wire-based or wireless means. Execution of commands may be controlled by a controller 130 in printing apparatus 100 and/or a controller in display system 21.

The delete function of block 75 may include collecting ink or toner or other residue from a deleted image and collecting the substances in a receptacle such as a toner receptacle. The deleting function may further include separating a mixed toner collection into component colors. The deleting function may further include transferring the previously deleted toner to one or more toner cartridges for addition usage (e.g., recycling). For example, a deleting function may be implemented similar to that described in embodiments of U.S. patent application Ser. No. 10/745,596, as referenced above.

According to some embodiments of the present invention, in the case where printing apparatus 100 is too wide to connect to the printable area of substrate 23, additional rollers such as auxiliary rollers 41, 42, and slides 44, 45 may be provided, for enabling the guide rolls 24 to slide into appropriate positions for stretching the substrate to a position adjacent to printing apparatus's printing 105 and/or deleting 115 units, so that printing apparatus 100 may print and/or delete images to/from the substrate.

Any combination of the above steps may be implemented. Further, other steps or series of steps may be used.

According to a further embodiment of the present invention, the display system may print at least one image onto a plurality of substrates, each substrate having a plurality of colors printed onto it. Upon erasing of such an image, the various colors that comprise the image on a particular substrate may be collected together, and the colors may be subsequently separated into the component colors.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A system, comprising:
a screen based display system including at least a substrate; and
a detachable printing apparatus to execute printing and deletion commands.

2. The system of claim 1, further comprising a server to configure printing and deletion commands for said printing apparatus.

3. The system of claim 1, further comprising a server to communicate printing and deletion commands to said display system.

4. The system of claim 1, further comprising a server to communicate printing and deletion commands to said printing apparatus.

5. The system of claim 1, wherein said printing apparatus includes a deletion unit.

6. The deletion unit of claim 5, comprising a toner-collecting unit.

7. The system of claim 1, wherein said printing apparatus verifies the identity of said display system.

8. The system of claim 1, wherein said screen based display system includes a first attachment mechanism, said printing apparatus includes a second attachment mechanism, said first and second attachment mechanisms capable of being mated.

9. A printing apparatus comprising:
a printing mechanism;
a deletion mechanism; and
a registration mechanism, to attach the printing apparatus to a display system.

10. The printing apparatus of claim 9, comprising a controller.

11. The printing apparatus of claim 9, comprising a communication unit, to communicate with said display system.

12. The printing apparatus of claim 9, comprising a communication unit, to communicate with a server.

13. The printing apparatus of claim 9, comprising an identifying mechanism.

14. The printing apparatus of claim 9, comprising a toner collecting mechanism.

15. A printable display system comprising:
a display window;
a printing substrate; and
a registration mechanism to connect the display system to a detachable printing apparatus.

16. The display system of claim 15, comprising guiding rollers to enable said printing substrate to be positioned adjacent to printing and deleting mechanisms of said detachable printing apparatus.

17. The display system of claim 15, comprising a communication unit.

18. The display system of claim 15, comprising a controller.

19. The display system of claim 15, comprising an identifying mechanism.

20. The display system of claim 15, further comprising auxiliary rollers and slides.

21. A method for printing and erasing screen based images, comprising:
attaching a detachable printing apparatus to a display system;
registering said detachable printing apparatus with said display system; and
executing a set of print commands.

22. The method of claim 21, comprising identifying said display system to said printing apparatus.

23. The method of claim 21, comprising:
configuring printing commands in a server; and
communicating said commands to at least one detachable printing apparatus.

24. The method of claim 21, comprising deleting a previous image.

25. The method of claim 21, comprising collecting deleted toner.
